(19) United States
(12) Patent Application Publication
(10) Pub. No.: US 2003/0026330 A1
(43) Pub. Date: Feb. 6, 2003

(54) Interface for the serial transmission of digital data

(76) Inventor: Ernst Ehling, Neuhausen (DE)

Correspondence Address: HARNESS, DICKEY & PIERCE, P.L.C., P.O. BOX 8910, RESTON, VA, 20195, US

(21) Appl. No.: 10/209,943

(22) Filed: Aug. 2, 2002

(30) Foreign Application Priority Data
Aug. 2, 2001 (DE) 10137835.1-31

(51) Int. Cl. H04B 1/38

(52) U.S. Cl. 375/220; 375/295

(57) ABSTRACT

A method for the serial transmission of digital data from a transmitter to a receiver is described. In the method, at least one data word is transmitted which has a plurality of bits. Also transmitted is an associated error bit which indicates whether the generation of the data word was error-free. Likewise, a plurality of associated test bits are transmitted, from which it is possible to deduce whether the transmission of the data word and of the error bit was error-free.

### FIELD OF THE INVENTION

The invention relates to a method and an interface for the serial transmission of digital data from a transmitter to a receiver.

### BACKGROUND OF THE INVENTION

In a machine tool, for example, it is necessary to transmit the digital measured values registered by a measuring system, which relate to the position of the workpiece to be machined, to a computing device. This can be achieved, for example, with a magnetostrictive measuring system for length measurement, as described in U.S. Pat. No. 5,923,164.

The measured values registered by the measuring system are in this case made available as digital data. For this purpose, known serial transmission devices and methods can be used, which permit a sufficiently high transmission rate. However, such serial transmissions do not contain any indication as to whether the data that have arrived at the receiver are error-free. The result of this can be that the computing device processes measured values transmitted erroneously as correct.

### SUMMARY OF THE INVENTION

It is an object of an embodiment of the present invention to provide a method and an interface for the serial transmission of digital data from a transmitter to a receiver with which the receiver can check whether the data obtained are error-free.

According to this embodiment of the present the invention, the object may be achieved by a method for the serial transmission of digital data from a transmitter to a receiver in which at least one data word is transmitted which has a plurality of bits in which an associated error bit is transmitted which indicates whether the generation of the data word was error-free, and in which a plurality of associated test bits are transmitted from which it is possible to deduce whether the transmission of the data word and of the error bit was error-free.

According to an embodiment of the present invention, the object is also achieved by a corresponding interface for the serial transmission of digital data from a transmitter to a receiver.

As a result of the transmission of the error bit, the receiver can detect whether an error has occurred during the generation of the associated data word. For example, if the measuring system of a machine tool detects the fact that the registration of the position of the workpiece to be machined was erroneous for any reason, then this can be notified to the computing device by activating the error bit. The computing device then uses the active error bit to detect the fact that the associated data word is erroneous and therefore must not be processed further.

As a result of the transmission of the test bits, the receiver can detect whether the transmission of the associated data word was error-free. For this purpose, the test bits are determined by the transmitter in accordance with a cyclic redundancy check (CRC), on the basis of the data to be transmitted. In the receiver, the CRC method is applied to all the data received, including the test bits. If the result is not equal to zero, then the receiver can conclude that there is a transmission error and stop the processing of the data received.

Overall, at least one embodiment of the present invention therefore achieves the situation in which, firstly, a high transmission rate is possible as the result of using a serial interface. Secondly, by way of the transmitted error bit and the transmitted test bits, the advantage is achieved that the receiver can check whether the data that have arrived at the receiver are error-free. Processing of erroneous data is therefore reliably avoided.

Here, at least one embodiment of the present invention permits not only checking on the receiver side as to whether the transmission of the data as such was error-free, but advantageously also checking as to whether the generation of the data to be transmitted was erroneous. In this way, extremely high reliability with regard to the error-free further processing of the data received is achieved.

In an advantageous development of an embodiment of the present invention, the test bits are transmitted after the data word and after the error bit. This is accompanied by the advantage that the test bits are in the correct position for the division carried out in the CRC method. The receiver can therefore subject all of the data received, including the test bits, immediately to the CRC method.

In a further advantageous development of an embodiment of the present invention, the error bit is transmitted before the data word and before the test bits. This results in the advantage that, in the event of an active error bit, the receiver does not have to read in the following associated data word and the following associated test bits at all, nor process them. An associated function bit is advantageously transmitted first. This makes it possible for the receiver to detect the start of the associated data, that is to say of the data word, of the associated error bit and of the associated test bits in a straightforward manner.

It is particularly expedient to use an embodiment of the the invention for the transmission of measured values from a preferably magnetostrictive measuring system to a computing device. In this case, the data words preferably represent measured values which have been acquired by the measuring system. The computing device is then preferably provided for the purpose of processing the measured values received, for example within the context of the control and/or regulation of a machine tool.

Further features, possible applications and advantages of embodiments of the present invention emerge from the following description of exemplary embodiments of the invention, which are illustrated in the figures of the drawing. Here, all the features described or illustrated, on their own or in any desired combination, form the subject matter of the invention, irrespective of their combination in the claims or their back-reference and also irrespective of their formulation or representation in the description or in the drawing.

### BRIEF DESCRIPTION OF THE DRAWINGS

FIG. 1 illustrates a schematic representation of an exemplary embodiment of an interface according to the present invention for the transmission of a data block, and

FIG. 2 shows a schematic representation of the transmission of a plurality of data blocks over the interface of FIG. 1.

### DETAILED DESCRIPTION OF THE PREFERRED EMBODIMENTS

For the control of a machine tool, a computing device is normally provided which, on the basis of registered measured values, drives actuating motors, for example, with which it is possible to move a tool table on which the workpiece to be machined is located.

For this control, it is necessary for the measured values registered by a measuring system to be transmitted to the computing device. For this purpose, an interface is provided and described hererin which defines the manner in which the measured values are transmitted from the measuring system to the computing device. In particular, the interface defines the hardware and software features of the interface.

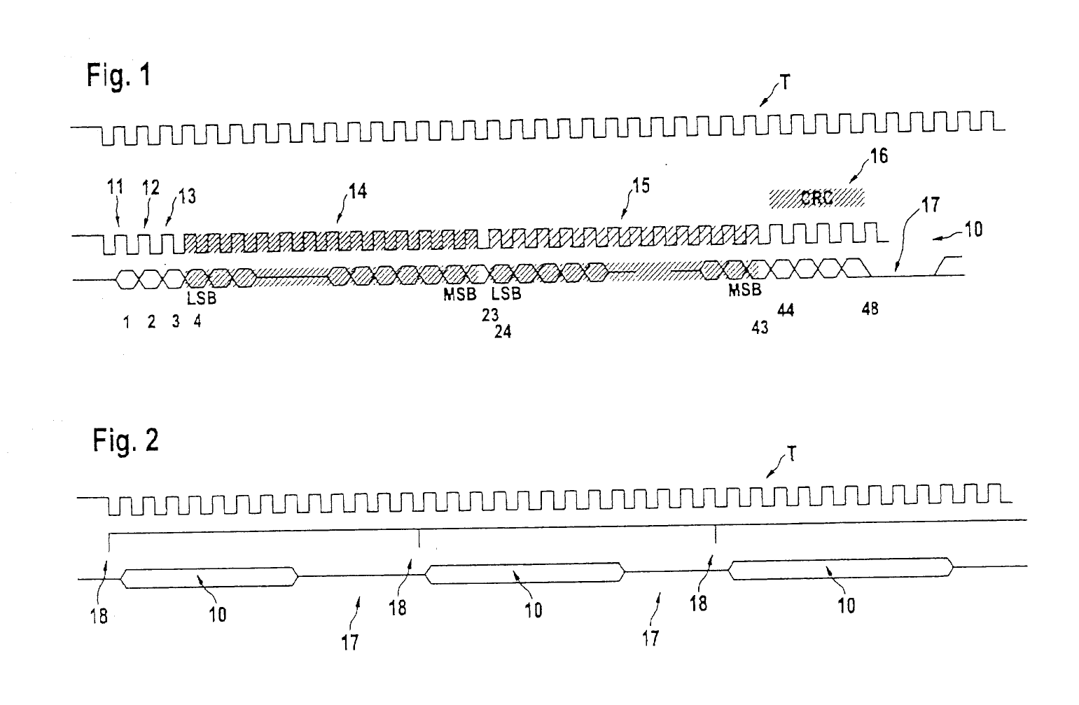

By using FIGS. 1 and 2, an interface for the transmission of measured values will be explained below. The measured values can be path lengths or time durations, it being possible in turn for the time durations to correspond to path lengths.

Since the interface can be used not only for the transmission of measured values, the following text always refers to data words. Since, as has been explained, the measured values are present as digital data, the data words are digital data.

As an example, it will be assumed that a single data word has a bit length of 20 bits. It is therefore possible, for example in a magnetostrictive measuring system for length measurement, to register a measured length of 5 meters with a resolution of 5 micrometers.

Furthermore, by way of example, it will be assumed that the transmission of data words is to take place at a frequency of 16 kilohertz, that is to say therefore that new data is to be transmitted every 62.5 microseconds.

The interface for the transmission of the data words is a serial and unidirectional interface. This means that the data words can be transmitted only serially from a transmitter, for example the measuring system, to a receiver, for example the computing device. Furthermore, the interface is a synchronous interface. This means that the bits of the data words to be transmitted are transmitted synchronously by using a clock, specifically in such a way that exactly one bit is transmitted at each positive edge of the clock.

The hardware is preferably an RS422 interface, as it is known, which is also designated a “serial synchronous interface (SSI)”. As an example, it will be assumed that the interface is operated with a clock of 1 megahertz.

In particular, the software definition of the interface is described below by using FIG. 1. Here, the aforementioned clock is illustrated schematically in FIG. 1 and provided with the abbreviation T.

A data block is provided which has a total of 48 bits. This data block is identified in FIG. 1 by the designation 10.

The data block 10 is composed of three system bits, a first data word, a second data word and five test bits, as they are known. The system bits, data words and test bits contained in the data block 10 belong together and, to this extent, form a unit of data to be transmitted jointly.

The three system bits occupy the first three bits, that is to say bits 1, 2 and 3 of the data block.

The first bit, which is identified by the designation 11 in FIG. 1, constitutes a function bit, as it is known. If this function bit 11 is active, that is to say is “1”, for example, this indicates that a data block 10 is present.

The second bit, which is identified in FIG. 1 by the designation 12, constitutes an error bit. If this error bit 12 is active, that is to say is “1”, for example, this indicates that the generation of one of the data words contained in the associated data block was erroneous.

In connection, for example, with a magnetostrictive measuring system, provision is normally made for the measuring system to carry out self-diagnosis or the like. The measuring system is therefore capable of detecting an error in the registration of the measured values. If such an error is determined by the measuring system with regard to a specific measured value, then the measuring system can set the aforementioned error bit 12. It is therefore indicated to the receiving computing device that the registration of the measured value contained in the data block transmitted was erroneous. The computing device can then further process this measured value separately.

It is pointed out that the error bit 12 does not relate to the transmission of data from the transmitter to the receiver but only to the generation of the data in the transmitter.

The third bit, which is identified by the designation 13 in FIG. 1, can be used freely and is therefore designated a free bit. In the case of a measuring system, this free bit 13 can be used, for example, to distinguish between measured values and other, general data. Likewise, the free bit 13 can be used to distinguish between different versions or configurations of the transmitter, that is to say for example of the measuring system.

The first data word, which is identified by the designation 14 in FIG. 1, occupies bits 4 to 23 of the data block 10. The second data word, which is identified by the designation 15 in FIG. 1, occupies bits 24 to 43 of the data block 10. As has already been mentioned, these data words 14, 15 can be measured values from a magnetostrictive measuring system. Furthermore, the data words 14, 15 can be values derived from such measured values, for example position values or the like. They can likewise be values calculated in any other way, for example speed values or the like. The aforementioned possibilities can be present here in pairs or in mixed form in an individual data block 10. As has likewise already been mentioned, the data words 14, 15 can also be other, general data.

The five test bits, which are identified in FIG. 1 by the designation 16, occupy bits 44 to 48 of the data block 10. These test bits 16 result from a “cyclic redundancy check (CRC)”. The test bits 16 can therefore also be designated as CRC bits.

The “cyclic redundancy check (CRC)” is a method in which the transmitter, that is to say for example the magnetostrictive measuring system, divides bits 1 to 43 by a predefined generator polynomial, as it is known, in order then to transmit the remainder produced by the division to the receiver as the aforementioned five test bits 16. In the receiver, that is to say for example in the computing device, the same division by the generator polynomial is carried out with all the bits 1 to 48 received, that is to say including the five test bits. Because of the inclusion of the five test bits 16 in the division, the result must be the value zero with no remainder in the case of a correct transmission. If this is so, then this means that the transmission of the data block 10 was error-free. If another value results, then this means that an error occurred during the transmission of the data block 10.

Using the five test bits 16, it is therefore possible to check whether the transmission of the data block 10 and therefore of the data words 14, 15 was error-free. This check therefore differs from the error bit 12 in that it relates only to the transmission of the data words 14, 15 as such. It is pointed out that the test bits 16 have nothing to do with the question as to whether the generation of the data words 14, 15 was error-free.

At the assumed clock rate of 1 megahertz, the transmission of the 48 bits of the data block 10 lasts for a total of 48 microseconds. Every 62.5 microseconds, a new data word is made available by the transmitter, that is to say for example by the magnetostrictive measuring system. There therefore remains a time period of 14.5 microseconds in which no transmission of data takes place. of this, in a magnetostrictive measuring system, 10 microseconds are used as a system-induced dead time.

The system-induced dead time, which is identified in FIG. 1 by the designation 17, can be used in the magnetostrictive measuring system to load the next measured value or values in parallel into appropriate shift registers, in order then to read them out serially in the context of the next transmission of measured values and transmit them to the computing device.

FIG. 2 illustrates three data blocks 10, as have been explained above using FIG. 1. The aforementioned dead time 17 is present between the respective data blocks 10.

It is pointed out that the clock T, as illustrated in FIG. 2, is not to scale but is intended to be indicated only symbolically.

In a first alternative, which is illustrated in FIG. 2, a continuous clock T is provided. This clock T is transmitted from the receiver, that is to say for example from the computing device, to the transmitter, that is to say for example the magnetostrictive measuring system.

As has already been explained, new data words 14, 15 are made available, for example by the magnetostrictive measuring system, every 62.5 microseconds. The time at which these new data words 14, 15 are ready to be transmitted is identified by the designation 18 in FIG. 2. After each of these times 18, in each case the data word 14, 15 which is newly available is transmitted from the transmitter, that is to say for example the measuring system, to the receiver, that is to say for example to the computing device, within the context of a new data block 10 together with the clock T.

In the alternative described, the receiver, that is to say for example the computing device, makes only the continuous clock T available. The initiation of the transmission of a data block 10 is carried out only by the transmitter, that is to say for example by the measuring system, specifically on every occasion when a new data word 14, 15 has been generated by the measuring system and has been made ready for transmission.

In a second alternative, which is not illustrated, no continuous clock is provided, instead the clock is present only during the transmission of the 48 bits of the data block 10. The clock T is therefore generated as a “burst”. The dead time 17 following a data block 10 is forced by the transmitter, that is to say for example the magnetostrictive measuring system, by the transmission signal being set to “0”, for example. The receiver, that is to say for example the computing device, monitors when the transmission signal is no longer at “0”, and therefore when the dead time has ended. A new “burst” of the clock T is then generated by the computing device and transmitted to the transmitter, that is to say for example to the magnetostrictive measuring system. Said signal initiates the transmission of the next data block 10 in the measuring system.

One further possibility in the interface described is that quite general data is transmitted instead of measured values. For example, in connection with a magnetostrictive measuring system, it is possible to transmit the available measuring length of the measuring system and/or the production date and/or the serial number of the measuring system as data words 14, 15.

Here, such general data can be distinguished from data to be transmitted per se, that is to say for example from the measured values, for example with the aid of the free bit 13. The receiver, that is to say for example the computing device, can then use the free bit 13 to decide whether this is general data or, for example, measured values. Alternatively, it is possible to provide the general data entirely at the start of a transmission, that is to say immediately after the devices necessary for the transmission have been switched on. In both cases, the general data can be repeated many times in a predetermined manner, in order to ensure reliable transmission.

What is claimed is:

1. A method for the serial transmission of digital data from a transmitter to a receiver, comprising:
transmitting at least one data word which has a plurality of bits in which an associated error bit is transmitted which indicates whether the generation of the at least one data word was error-free; and
transmitting a plurality of associated test bits from which it is possible to deduce whether the transmission of the at least one data word and of the associated error bit was error-free.

2. The method as claimed in claim 1, wherein the associated test bits are transmitted after the at least one data word and after the error bit.

3. The method as claimed in claim 1, wherein the error bit is transmitted before the at least one data word and before the associated test bits.

4. The method as claimed in claim 1, wherein two data words are transmitted together with the error bit and the associated test bits.

5. The method as claimed in claim 1, further comprising first transmitting an associated function bit.

6. The method as claimed in claim 1, wherein the associated test bits are formed on the basis of data to be transmitted before them.

7. The method as claimed in claim 1, wherein the at least one data word, the error bit, and the associated test bits, together form a data block, and in which a plurality of data blocks are transmitted successively.

8. The method as claimed in claim 7, wherein a dead time is left between transmission of two successive data blocks.

9. The method as claimed in either of claims 8, wherein the transmission of a data block is initiated after a time at which a new data word is made ready for transmission.

10. Transmitting measured values from a magnetostrictive measuring system to a computing device in accordance with the method of claim 1.

11. An interface between a transmitter and a receiver, via which digital data is transmitted serially, wherein at least one data word, an error bit and a plurality of test bits belonging to the transmission are provided, the data word having a plurality of bits, the error bit indicating whether the generation of the data word was error-free, and wherein it is possible to deduce from the test bits whether the transmission of the data word and of the error bit was error-free.

12. The interface as claimed in claim 11, wherein first the error bit, then the at least one data word and then the test bits are provided for transmission.

13. The interface as claimed in claim 11, wherein two data words are provided for transmission.

14. The interface as claimed in claim 11, wherein a function bit is provided for transmission.

15. The interface as claimed claim 11, wherein the at least one data word, the error bit, and the test bits together form a data block, and in which a plurality of data blocks are provided successively for transmission.

16. The interface as claimed in claim 11, wherein the transmitter is a magnetostrictive measuring system and the receiver is a computing device.

17. The interface as claimed in claim 11, wherein a clock is provided for the transmission of the data, the clock having a clocking rate of 20 kilohertz to 2 megahertz.

18. The interface as claimed in claim 11, wherein a bit length of 20 bits is provided for the at least one data word.

19. The interface as claimed in claim 11, wherein the test bits are based on a cyclic redundancy check (CRC) and have a bit length of 5 bits.

20. The interface as claimed in claim 11, wherein a data block is provided for transmission every 62.5 microseconds.

21. The method as claimed in claim 2, wherein the error bit is transmitted before the at least one data word and before the associated test bits.

22. The method as claimed in claim 2, wherein two data words are transmitted together with the error bit and the associated test bits.

23. The method as claimed in claim 3, wherein two data words are transmitted together with the error bit and the associated test bits.

24. The method as claimed in claim 4, further comprising first transmitting an associated function bit.

25. The method as claimed in claim 24, wherein the data words, the error bit, the associated test bits, and the associated function bit together form a data block, and in which a plurality of data blocks are transmitted successively.

26. The method as claimed in claim 4, wherein the data words, the error bit, and the associated test bits, together form a data block, and in which a plurality of data blocks are transmitted successively.

27. The interface as claimed in claim 12, wherein two data words are provided for transmission.

28. The interface as claimed in claim 12, wherein a function bit is provided for transmission before the error bit.

29. The interface as claimed in claim 11, wherein a clock is provided for the transmission of the data, the clock having a clocking rate of 20 kilohertz to 1 megahertz.
